(19) United States
(12) Patent Application Publication
(10) Pub. No.: US 2009/0130291 A1
(43) Pub. Date: May 21, 2009

(54) Dried Citrus Peels as an Absorbent Carrier for Commercial Animal Feed Additives

(76) Inventors: Stephen F. Driggers, Marietta, GA (US); David L. Wilson, Commerce, GA (US); Catherine A. Wilson, Commerce, GA (US)

Correspondence Address: ATTN: E.J. ASBURY III;TAYLOR BUSCH, LLP, 1600 PARKWOOD CIRCLE, SUITE 200, ATLANTA, GA, 30339, US

(21) Appl. No.: 12/163,971

(22) Filed: Jun. 27, 2008

Related U.S. Application Data
(60) Provisional application No. 60/946,428, filed on Jun. 27, 2007.

(51) Int. Cl. A23K 1/175

(52) U.S. Cl. 426/616; 426/442; 426/624; 426/656; 426/630

(57) ABSTRACT

Particles of untreated citrus byproduct consisting of dried citrus peels and pulp can be used to absorb certain useful liquid animal feed additives up to 125% of the dried peel's weight, thereby acting as an effective and efficient absorbent carrier. Stated another way, a citrus peel/liquid animal feed mix may be produced which contains up to 55% by weight liquid animal feeds, with only a 45% by weight, citrus peel carrier. The resulting mixtures are an effective and easy handling means to introduce desired commercial animal feed additives into animal feeds with a carrier that has good palatability to livestock and poultry. These mixtures are dry and free flowing.

### CROSS-REFERENCE TO RELATED APPLICATION

This application claims the benefit of U.S. Provisional Application Ser. No. 60/946,428, filed on Jun. 27, 2007, and the entirety of which is hereby incorporated herein by reference.

### BACKGROUND OF THE INVENTION

1. Field of the Invention

The present invention generally relates to chemical carrier compositions used in animal nutrition. More particularly, the present invention relates to the use of dried citrus peels as an absorbent carrier for liquid animal feed additives.

2. Description of the Related Art

Commercial animal feeds are usually mechanical mixtures of many different grains and other sources of nutrition along with desired additives to give the target animal a nutritionally balanced diet. Usually, many tons of animal feed are mixed either continuously or batch wise in relatively short mix times. Many times these desired additives are liquids that have been absorbed onto a dry carrier in order that they might be added during the feed mixing operation at some inclusion rate that will give the animal feed mixture the content of the particular additives in the desired amounts in the finished feed. These desired additives may include but are not limited to various organic and inorganic acids, sources of energy in the diet, minerals, or vitamins. Animal feed additives of interest include, but are not limited to certain liquid inorganic acids, organic acids, and medium chain fatty acids along with their ammonium, sodium, and potassium salts.

In order for a product or mixture of products to be a useful dry absorbent carrier for the purpose of incorporating certain useful liquids in animal feed it should address several areas. The carrier should be sufficiently absorbent so that a concentrated feed additive as practicable is manufactured. Animal Nutritionists use many different grains and other sources of nutrition to formulate a balanced feed for the target animal. Concentrated animal feed additives leave more room in the formulas for a ton of feed for alternative ingredients to be used than do lesser concentrated additives. This gives the nutritionist more flexibility in choosing ingredients for the feed and the opportunity to create a more economical feed.

To allow a concentrated feed additive to be used, a unit weight of the dry chemical carrier must be able to absorb sufficient quantities of liquid nutritional additives. For example, if a chemical carrier is 20% absorbent by weight, it will require 5 pounds of carrier to absorb 1 pound of liquid feed additive. Therefore, the total weight of delivery of the 1 pound of desired feed additive within a ton of animal feed is then 6 pounds. If a more absorbent chemical carrier is used, for example one which 50% absorbent by weight, it will require only 2 lbs of the dry carrier to absorb the desired 1 pound of feed additive. The total weigh of delivery of the 1 pound of feed additive is therefore 3 pounds in the final feed. With the more absorbent carrier, 3 lbs are available to be used for other useful feed components, or alternatively, a more concentrated, weight and volume efficient product may be delivered to the end user. For these reasons, the absorbability of the chemical carrier is of great practical and economic importance, and the cost of a chemical carrier with a higher absorbability may be justified.

Nutritionists must often make choices between ingredients based on how much space they would take up in the finished feed. Space is defined as being the inclusion rate necessary for any given ingredient to be used in order to get the desired nutrient value in 2000 pounds (one ton) of the finished feed. The nutritionist must formulate the ration to a desired nutritional balance using a combination of many preferred ingredients. Each ingredient has a cost associated with the nutritional value it contributes to the feed, verses the amount of space it takes up in the formulation for that specific ingredient. It is particularly useful if the ingredient has as many useful aspects from a nutritional stand point as possible. It is especially useful if a dry absorbent carrier can in its own right provide some nutritive value beyond its intended use as a vehicle to absorb certain desired liquid ingredients.

Other important considerations for a practical chemical carrier include that the carrier should be economical and readily available. The cost of the carrier, as delivered to the feed mill plant producing the animal feed, or animal nutritional supplement, must be an acceptable percentage of the production cost. The cost of the process of absorbing the nutritional supplements onto the chemical carriers must also be considered. Some chemical carriers require extensive drying prior to exposure to the desired liquid supplement, or require the supplement be applied at an elevated temperature. The carrier should be consistent and repeatable from load to load in bulk density, absorbency, chemical and nutritional composition. Of special importance, the carrier should be palpable to the target animal. Many of the supplements fed to target animals are not readily consumed by the animal in raw form due to unpleasant palatability. And an added benefit to the carrier would be if it provides some nutrient value to the feed.

Considerations important to the manufacturer of the animal feed, or animal nutritional supplement, include that the dry absorbent chemical carrier should possess good flow-ability characteristic even when compounded with liquid additives. The dry absorbent carrier should be easy and safe for feed mixing personnel to produce, and for personnel to handle and feed to livestock. As many of the liquid feed additives are acids, operating personnel are sometimes irritated by pungent fumes, especially the fumes of organic acids and hydrochloric acid. Of added value, the dry absorbent carrier system should be capable of being used in a manner that will reduce the vapor pressure of volatile components within the liquid feed additives in order to reduce the out gassing of those components.

Dry carriers such as bentonite, vermiculite, and fumed silica have long been used as absorbents for desired liquid animal feed additives. Such resulting mixtures are introduced into mixtures of grains, and other ingredients to produce finished animal feeds. Bentonite and vermiculite are available in many parts of the world where there are sufficient deposits of these minerals. Fumed silica is a synthetic product available from many sources. Fumed silica is very highly absorbent, but is also very expensive. This class of carriers is highly efficient and economical, but contributes little to the nutritional requirements of the target animal. Ingredients such as potassium chloride and calcium carbonate supply nutrients useful in some diets but have limited inclusion rates for dietary reasons. This class of carriers has very little absorbent capacity compared to Bentonite, vermiculite, and fumed silica.

Sugar beet pulp has long been used in Europe as a dry chemical carrier. Though it is highly absorbent, it is limited in its use and supply. The utility of beet pulp is dependent on sugar beet crop yields. Sugar beets tend to be grown in limited geographical areas determined by climate and soil. In many cases, sugar beet production is supported by government subsides and is therefore unlikely to ever be produced in abundance.

Accordingly, what is needed in the art is a dry natural organic absorbent chemical carrier with the ability to absorb large amounts of liquid feed additives by weight. The dry natural organic absorbent carrier composition should be readily available, consistent and repeatable, and economical in use. The dry natural organic absorbent carrier composition should also exhibit good working qualities in regard to flow-ability and out gassing when loaded with liquid feed additives. The process of absorbing the liquid feed additives into the dry natural organic absorbent chemical carrier should be readily incorporated into a production process and should be efficient, repeatable, and economical. It is very desirable that the dry natural organic absorbent carrier add to the nutritional value of the feed instead of being inert and having no real nutritional value. It is also very desirable for the dried natural organic absorbent carrier to improve the palatability of the feed. It is very desirable that the dried natural organic absorbent carrier to be of not only natural and organic, but be of a renewable resource in origin. It is to such a carrier composition and process that the present invention is directed.

### SUMMARY OF THE INVENTION

The disadvantages of the prior art are overcome by the present invention which, in one aspect, is a process for the creation of an animal nutritional feed supplement composition; the process including the use of an absorbent chemical carrier. The chemical carrier including citrus byproduct obtained from citrus juice expressing, said citrus byproduct including citrus peel and being in a dried state. Adding a blooming agent to the chemical carrier to form a pre-mix, then mixing the blooming agent by means of mechanical agitation uniformly into the citrus byproduct for a period of time. The blooming agent then blooming the citrus byproduct within the pre-mix. Adding liquid feed supplements to the bloomed chemical carrier. The liquid feed supplements then being substantially absorbed by the chemical carrier to form a substantially dry feed supplement composition.

In another aspect of the present invention, the time period is greater than 30 seconds. The dried citrus byproduct has a moisture content between about 5% and 12% by weight. The blooming agent is at least one of the group including formic, acetic, propionic, butanoic, lactic, citric, caprylic, capric, caproic, valeric, butaric acid, trimethyl glycine, choline, lysine, or certain other amino acids, or a combination of a preceding acid with its salt in solution. In one aspect, the blooming agent includes Propionic Acid. In another aspect, the blooming agent includes a water solution of propionic acid and ammonium proprionate. The blooming agent is added to the chemical carrier in a ratio of between 1% to 5% on an active acid basis of the weight of the dried citrus byproduct.

In another aspect of the present invention, the liquid feed supplements include at least one of an organic or medium chain fatty acid selected from the group including formic, acetic, propionic, butanoic, lactic, citric, caprylic, capric, caproic, valeric, butaric acid, or a combination of a preceding acid with its salt in solution, trimethyl glycine, choline, lysine, glycerin, or certain other amino acids. The liquid feed supplements may include at least one of an inorganic acid selected from the group including phosphoric, sulfuric, or hydrochloric acid. The liquid feed supplements may include at least one of glycerin or propylene glycol.

In another aspect of the present invention, the liquid feed supplements are added to the bloomed dried citrus carrier in a ratio of between 10% to 55% of the weight of the dried citrus byproduct. The feed supplement composition is a free flowing mixture having an angle of repose of less than 40 degrees. The feed supplement composition is non-clumping. In another aspect, prior to use in the chemical carrier composition, the citrus flake is ground by mechanical means to produce a particle size finer than a 6 mesh Tyler screen designation.

In another aspect of the present invention, the liquid feed supplements absorbed onto the bloomed citrus byproduct carrier when fed in the diet of a cow with subclinical hypocalcemia, positively affect the negative dietary cation-anion difference which governs calcium metabolism. In another aspect, the liquid feed supplements absorbed onto bloomed citrus byproduct carrier which when fed to a cow post calving, would provide a source of energy, organic acids and fiber.

In another aspect, the present invention provide an animal nutritional feed supplement composition; the composition including an absorbent chemical carrier composition. The chemical carrier including citrus byproduct obtained from citrus juice expressing, said citrus byproduct including citrus peel and being in a dried state, the chemical carrier having between about 10 and about 100 volume percent of the citrus byproduct, and up to 90 volume percent of a secondary chemical carrier other than citrus byproduct. A blooming agent added to the chemical carrier to form a pre-mix, wherein the blooming agent is mixed into the chemical carrier for a period of time. And wherein the liquid feed supplements are added to the pre-mix, the liquid feed supplements then being substantially absorbed by the chemical carrier to form a substantially dry feed supplement composition. The secondary chemical carriers include beet pulp, brewers grains, distillers grains, soybean meal, peanut hulls, expanded vermiculite, Bentonite, fumed silica, or cotton seed meal.

In another aspect of the present invention, the blooming agent is at least one of the group including formic, acetic, propionic, butanoic, lactic, citric, caprylic, capric, caproic, valeric, butaric acid, trimethyl glycine, choline, lysine, or certain other amino acids, or a combination of a preceding acid with its salt in solution. The blooming agent includes Propionic Acid, or the blooming agent includes a water solution of propionic acid and ammonium proprionate. The blooming agent being added to the chemical carrier in a ratio of between 1% to 5% on an active acid basis of the weight of the dried citrus byproduct.

In another aspect of the present invention, the liquid feed supplements include at least one of an organic or medium chain fatty acid selected from the group including formic, acetic, propionic, butanoic, lactic, citric, caprylic, capric, caproic, valeric, butaric acid, or a combination of a preceding acid with its salt in solution, trimethyl glycine, choline, lysine, glycerin, or certain other amino acids. The liquid feed supplements may include at least one of an inorganic acid selected from the group including phosphoric, sulfuric, or hydrochloric acid. The liquid feed supplements may also include at least one of glycerin or propylene glycol.

In another aspect of the present invention, the liquid feed supplements are added to the bloomed dried citrus carrier in a ratio of between 10% to 55% of the weight of the dried citrus byproduct. The feed supplement composition is a free flowing mixture having an angle of repose of less than 40 degrees. The feed supplement composition is non-clumping. In some aspect, prior to use in the chemical carrier composition, the citrus flake is ground by mechanical means to produce a particle size finer than a 6 mesh Tyler screen designation.

In another aspect of the present invention, the liquid feed supplements absorbed onto the bloomed citrus byproduct carrier which when fed in the diet of a cow with subclinical hypocalcemia, positively affect the negative dietary cation-anion difference which governs calcium metabolism. In another aspect, the liquid feed supplements absorbed onto bloomed citrus byproduct carrier which when fed to a cow post calving, would provide a source of energy, organic acids and fiber.

These and other aspects of the invention will become apparent from the following description of the preferred embodiments taken in conjunction with the following figures and tables. As would be obvious to one skilled in the art, many variations and modifications of the invention may be effected without departing from the spirit and scope of the novel concepts of the disclosure.

### BRIEF DESCRIPTION OF THE DRAWINGS

FIG. 1 is a bar graph of the weight of test and control cattle in a feed test.

FIG. 2 is a bar graph of the average pounds of feed consumer per day by test and control cattle in a feed test.

FIG. 3 is a comparison of the average daily weight gain of test and control cattle in a feed test.

FIG. 4 is a graph of a measure of the digestibility of the feed supplement for test and control cattle in a feed test.

### DETAILED DESCRIPTION OF THE INVENTION

The invention presents a unique natural organic absorbent chemical carrier for liquid feed additives, and a process of incorporating the liquid feed additive into the chemical carrier. Particles of untreated citrus byproduct including dried citrus peels and pulp can be used to absorb certain useful liquid animal feed additives up to 122% of the dried peel's weight, thereby acting as an effective and efficient absorbent carrier. Stated another way, a citrus peel/liquid animal feed mix may be produced which contains up to 55% by weight liquid animal feeds, with only a 45% by weight, citrus peel carrier. The resulting mixtures are an effective and easy handling means to introduce desired commercial animal feed additives into animal feeds with a natural organic absorbent carrier that has good palatability to livestock and poultry. The resulting compositions are dry and free flowing.

An economical source of a natural organic absorbent chemical carrier is dried citrus peel or dried citrus pulp which is a voluminous byproduct of citrus juice extraction operations. The dried citrus peel and pulp are commonly referred to as citrus byproduct. Citrus byproduct is widely produced throughout the world. Dried citrus byproduct is manufactured as fruit is harvested and processed. It is available during most of the year in any given geographic citrus growing region. Between crops, the peel is easily stored. This citrus byproduct material is typically dried as citrus waste material that is widely varying or heterogeneous in terms of components, particle sizes and even shapes.

As used herein, this heterogeneously sized dried citrus waste material is referred to as being flaked. Typical dried citrus byproduct material is composed of primarily large particles having a general length or width or size of about ½ inch or greater, while also including a relatively low volume of fine particles. This flaked dried citrus byproduct can include fine particles on the order of 1% by weight, usually less than 10% by weight, with at least 10% by weight of irregularly shaped particles in excess of ¾ inch in size. Typical moisture contents of this flaked dried citrus byproduct range between about 5 and about 12 weight percent moisture, based upon the total weight of the byproduct, typically between about 7 and 11 weight percent. Where greater moisture reduction cost is acceptable, a moisture content of between about 8 and 9 weight percent can be practiced.

There is no need to resize or uniformly shape the flaked dried citrus byproduct in the inventive process and composition. It can be used as the product of traditional citrus residue processing into so-called dried pulp. This typically includes a so-called liming process in which the raw, wet citrus residue is treated with calcium oxide (“quicklime”), pressed and dried into loose dried pulp. This can serve as the dried citrus byproduct as used herein. Details on the production of this loose dried pulp can be found in Braddock, Handbook of Citrus By-Product and Processing Technology, Chapter 10, “Dried Pulp, Pellets and Molasses,” pages 135-148, incorporated by reference hereinto.

The dried citrus byproduct can be flaked, ground, or palletized depending on the consistency of the final product desired. As used herein, citrus byproduct includes all flaked, ground, or palletized forms. All forms of dried citrus particles show ability to absorb useful liquid animal feed additives, but the flaked and ground forms are preferred. Particle sizing and consistency are varied as desired in order to be consistent to the final animal feed being produced.

Table I displays a typical analysis of values of Dried Citrus peel that are important to animal nutritionists:

TABLE I

| | Range | Typical Value |
|---|---|---|
| Total Digestible Nutrient (TDN) content | | 74% |
| Protein | 5.0-9.3% | 6.2% |
| Crude Fiber | 6.4-16.8% | 12.3% |
| Fat | 1.3-9.1% | 3.7% |
| Calcium | | 2.5% |
| Ash | 3.1-8.4% | 4.7% |
| Moisture | 3.5-13.7% | 8.6% |

Citrus peel largely consists of cellulose, hemicellulose and pectin. Cellulose is a long chained polysaccaride. A hemicellulose can be any of several heteropolymers (matrix polysaccharides) present along with cellulose. While cellulose is crystalline, strong, and resistant to hydrolysis, hemicellulose has a random, amorphous structure. Hemicellulose contains many different sugar monomers. In contrast, cellulose contains only anhydrous glucose Unlike cellulose, hemicellulose (also a polysaccharide) consists of shorter chains—500-3000 sugar units as opposed to 7,000-15,000 glucose molecules per polymer seen in cellulose. In addition, hemicellulose is a branched polymer, while cellulose is unbranched. Hemicelluloses are embedded in the cell walls in chains, they bind with pectin to cellulose to form a network of cross-linked fibres. Pectin is a heteropolysaccharide derived from the cell wall. Pectin helps bind the cells of the peel together.

Acids act to convert (“hydrolyze”) cellulose and hemicellulose into simpler sugars (hexose and pentose, or “C6 and C5” sugars) by hydrolysis. Acids also help break down pectins in the same way. Instead of total hydrolysis, a partial hydrolysis reaction opens up the hard, dry structure of the dried citrus peel by severing long polysaccharide chains into shorter, more open, more absorbent structures. Severing these long complex chains of cellulose, hemicelluloses, and pectin into shorter, simpler chains gives rise to more interstitial sites available for absorption of certain liquids.

The initial addition of an organic acid, like propionic acid, or an inorganic acid, like hydrochloric acid, to the citrus byproduct permeates, blooms, and opens the cellulous of the citrus flake allowing for a higher absorption of the remaining liquids in the desired feed mix. The organic acid addition hydrates or hydrolyzes the cell wall of the citrus flake cellulous, increasing the permeability of the cellulous, and resulting in a more absorptive citrus byproduct solid. As used herein, all aspects of this transformation are referred to as “blooming” the citrus byproduct. Citrus byproduct which has been transformed is referred to herein as “bloomed.” The organic acid, or acids, used to bloom the citrus byproduct are referred to herein as the “blooming agent.” The blooming transformation takes place in such a short time period as to fit well into current commercial technology for the production of animal feed additives on dry absorbent carriers.

If liquid animal feed supplements are added to raw citrus flake, an absorption rate of only 20-25% may be achieved. However, by adding an organic or inorganic acid blooming agent of 1% to 5% or greater on an active acid basis, and mechanically incorporating, or mixing, the flake and organic acid pre-mix, a partial hydrolysis reaction, or blooming, of the citrus flake occurs. By blooming the citrus flake prior to the addition of the bulk of the desired liquid feed additives, the absorptive properties of the citrus flake may be increased up to the range of 55% by weight of finished product. The remaining liquid feed additives may then be added to the bloomed flake. This order of liquid additions to the citrus byproduct is essential to obtain an absorption rate of 55% by weight.

The absorbability of untreated dried citrus peel was compared to the absorbability of bloomed dried citrus peel. In order to mix test formulations a test the absorbance of untreated dried citrus peel a pilot plant scale stainless steel double helix ribbon dry blender that simulates equipment found in a commercial mixing plant was used as the mixing device. A Transcell Model TI-500E platform scale precision 1.00±0.01 pounds was used measure ingredients. Each formulation tested started with 25.00 pounds dried citrus pulp. Next, a quantity of each of the desired ingredients was weighed into a separate container. This was the starting weight. The mixer was started and the time noted. When acid product is added for blooming, the mix time is 1 minute before adding the next ingredient. Liquid test ingredients were added through top of mixer in a manner that simulates conditions found in a commercial mixing plant. The desired liquid was continuously added and material was observed until it no longer was able to absorb or become of a consistently that would not easily flow through commonly encountered conveying and bagging equipment. Total mix time did not exceed 5 minutes. When the desired liquid addition was finished, each container of desired liquid was back weighed in order to determine the amount of liquid added. This is the final weight. Then the percentage test liquid and total liquid added were calculated. The results are tabulated in Table II below:

TABLE II
Liquid Absorbed On To Untreated and Bloomed Dried Citrus Peel*

| | Pounds 65% | Pounds Test | % of total mix | |
|---|---|---|---|---|
| | Ammonium | Liquid Ingredient | that is Test | % of Total |
| | Propionate added | added and | Liquid | Mixture that |
| Liquid Test | for blooming | absorbed onto | Ingredient | is Liquid |
| Ingredient | effect | dried citrus peel | absorbed** | Added*** |
| Water | 0 | 15.0 | 37.5 | |
| Glycerin | 0 | 14.5 | 36.6 | |
| Propionic | 0 | 13.25 | 34.6 | |
| acid | | | | |
| Propylene | 0 | 10.85 | 30.3 | |
| glycol | | | | |
| Citrus Oil | 0 | 11.7 | 31.9 | |
| Medium | 0 | 8.25 | 24.8 | |
| Chain Fatty | | | | |
| Acids | | | | |
| Feed Grade | 0 | 33.05 | 24.3 | |
| Lactic Acid (80%) | | | | |
| Propylene | 1.5 | 23.05 | 41.9 | 42.0 |
| Glycol | | | | |
| Medium | 1.5 | 18.25 | 42.2 | 43.3 |
| Chain Fatty | | | | |
| Acids | | | | |
| Glycerin | 1.5 | 22.85 | 47.8 | 47.9 |

*25.00 lbs dried citrus peel basis of each composition
**total weight of mix = (25.00 lbs dried citrus peel) + (1.5 lbs Ammonium Propionate, if added for blooming) + (number of pounds of desired test liquid absorbed). % Test Liquid absorbed = (number of pounds of desired test liquid absorbed)/(total weight of mix) × (100)
***% Total Liquid Absorbed = [(number of pounds of desired test liquid absorbed) + (1.5 lbs Ammonium Propionate, if added for blooming)]/(total weight of mix) × (100)

The test data show that the blooming processed enabled 25.00 lbs of citrus peel to absorb 22.85 pounds of glycerin or 47.8% by weight compared to 14.5 pounds of glycerin or 36.6% by weight that was absorbed onto untreated dried peel. The test data show that the blooming processed enabled 25.00 pounds of citrus peel to absorb 18.25 pounds of medium chain fatty acid or 42.2% by weight compared to 8.25 pounds of medium chain fatty acid or 24.8% by weight that was absorbed onto untreated dried peel. The test data show that the blooming processed enabled 25.00 lbs of citrus peel to absorb 43.05 pounds of propylene glycol or 41.9% by weight compared to 10.85 pounds of propylene glycol or 30.3% by weight that was absorbed onto untreated dried peel. In summary, the data show that the bloom process can substantially increase the absorbent capacity of dried citrus peel in a commercial manufacturing process.

The blooming effect of the addition of an acid or a mixture of acid and its salt to the dried citrus peel is time dependent. Noticeable increase in absorbency takes place within one minute of the addition of the blooming agent to the dried citrus peel. The rate of the hydrolysis reaction can be affected by acid concentration, heat, acid activity as expressed as pKa. As is known to those skilled in the art, the rate of hydrolysis reaction is increased as acid concentration increases, and is increased as heat increases, and is faster if one acid is more dissociated at a given concentration than another. It is known to those skilled in the art that pKa values compare acid strengths in respect to dissociation. The higher the pKa value, the weaker the acid. Hydrochloric acid has a pKa value which is lower compared to a pKa value for acetic acid. Therefore, hydrochloric acid is much stronger than acetic acid and would be expected to perform a hydrolysis reaction faster than would acetic. Never the less, there is some amount of time that is necessary for the reaction to take place. Adding a small amount of the blooming agent, allowing one minute time for the blooming process, then adding the rest of the acid will result in the citrus peel carrier being able to absorb more total acid compared to adding all the acid at once and then blending for uniformity purposes.

An experiment was performed by adding propionic acid as fast as possible to 25.00 lbs of dried citrus peel in a pilot scale ribbon mixer.

| | time | | | |
|---|---|---|---|---|
| | | | | +120 |
| | 0 | +45 seconds | +90 seconds | seconds* |
| Propionic acid | 6.0 lbs added | 3.5 lbs | 2.5 lbs | 1.25 lbs |
| added until | | increment | increment | increment |
| mixture wet | | added | added | added |
| | Added until | Added until | Added until | Added until |
| | appeared wet | appeared wet | appeared wet | appeared wet |

*Test was ended after addition at 120 seconds.

The table data illustrates that there is a correlation between time and total amount of a liquid absorbed. In other words, 6.0 pounds added at one time made the dried citrus peel appear that it was unable to absorb more propionic acid. Had all of the total 13.25 pounds of propionic acid been added at once the mix would be too wet for processing, cause clumping and excess unabsorbed acid would leak from the bottom discharge chute of the mixer. In order to be able to absorb the total 13.25 pounds of acid the blooming process had to take place.

The Blooming agent may be a single chemical composition or a combination of chemical compositions which bloom the citrus flake. The chemical compositions may be selected from the group including formic, acetic, propionic, butanoic, lactic, citric, caprylic, capric, caproic, valeric, butaric acid, a combination of a preceding acid with its salt in solution, trimethyl glycine, choline, lysine or certain other amino acids. Solutions of these organic acids and their ammonium, sodium, or potassium salts may be used singularly or in combination to bloom the byproduct.

In one embodiment of the present invention, an example of such a blooming agent could be propionic acid. In an alternative embodiment, a solution of propionic acid and ammonium proprionate such that solution's pH is less than 6.8. In another embodiment of the present invention, an example of such a blooming agent could be formic acid. In an alternative embodiment, a solution of formic acid and ammonium formate such that solution's pH is less than 6.8.

The blooming agent may also be an inorganic acids such as hydrochloric, sulfuric, or phosphoric acid, and solutions containing the acid their salts, such as a solution of hydrochloric acid and its salt, ammonium chloride, potassium chloride or sodium chloride. The pH of such a solution is to be less than 6.8. Solutions of these inorganic acids and their ammonium, sodium, or potassium salts may be used singularly or in combination, or may be used in combination with the organic acids above to bloom the byproduct.

In one embodiment of the present invention, the blooming agent may be 5-100%, acid by weight or its salts. The higher the concentration, the more economically efficient use of space in the composition, the more room left for other desired ingredients. This solution is defined as 5-100% by weight propionic acid. The ammonia range is from 2-18% ammonia by weight of the solution. The pH range of the solution is less than 6.8. The higher the acid concentrations in the blooming agent, the more economically efficient use of space in the chemical carrier composition, and the more room left for other desired liquid supplement ingredients.

The purpose of the natural organic absorbent chemical carrier is to absorb useful quantities of liquid animal feed supplements. The feed supplements may then be fed to the animal along with or as an ingredient in the animal's regular daily feed. As may be appreciated by those skilled in the art, the common liquid feed supplements include organic acids, medium chain fatty acids, and inorganic acids. The liquid organic acids and medium chain fatty acids include but are not limited to formic, acetic, propionic, butanoic, lactic, citric, caprylic, capric, caproic, valeric, butaric acid, or a combination of a preceding acid with its salt in solution. The most common inorganic acids included hydrochloric acid and phosphoric acid, but may also include sulfuric acid. As used herein, liquid inorganic acids, organic acids, and medium chain fatty acids include the ammonium, sodium, and potassium salts of those acids. The combination solution of the acid and its salt must have a pH less than 6.8. Examples of salts of such acetic acids are ammonium acetate, sodium acetate, or potassium acetate. Other important liquid feed supplements which may be added to the natural organic absorbent chemical carrier include, but are not limited to, glycerin, propylene glycol, choline, trimethyl glycine, lysine, other amino acids, and certain liquid vitamins.

The liquid feed supplements may be, but are not limited to, essential and non essential amino acids, that are either lacking in the animal's diet or are present in amounts below those desired for sound nutrition. These liquid feed supplements may be organic compounds for the prevention of mold, yeast, or may be useful as antioxidants in order to protect the other ingredients in the feed. The liquid feed may also include vitamins or minerals that are lacking in the animal's diet or are in amounts below those desired for sound nutrition.

The blooming agent is added to the citrus byproduct and the mixture is agitated or incorporated to evenly coat the outer surfaces of the byproduct solids. In practice this may be done by a mechanical mixer, a mechanical ribbon, a double ribbon, plow mixer, shear mixer, a mechanical auger, a vibration mixer, or a paddle mixer, or by other mixing means as readily known to those skilled in the art. The citrus byproduct and blooming agent then form a composition pre-mix. As previously stated, the blooming reaction in the composition pre-mix occurs rapidly and may take as little as 30 seconds of agitation to see a measurable benefit in the flake absorption ability. In practice, the blooming process is substantially concluded after 150 seconds. As will be appreciated by those skilled in the art, the time required for substantially blooming the flake may vary by the quantity of blooming agent added to the byproduct, the effective amount of coating of the solid surfaces of the byproduct, the amount of agitation or incorporation of and the size of the solids of the raw citrus byproduct. In one embodiment of the present invention, a bloom reaction time of at least 30 seconds is allowed.

As may be appreciated to those skilled in the art, the time period during which the citrus byproduct may be a dynamic time period as present in a continuous production process of an animal feed mill. The natural organic absorbent chemical carrier may not only be treated in discrete batches, but rather the citrus byproduct may be exposed to a blooming agent while flowing in a production process, and agitated to distribute the blooming agent on the outer surfaces of the solids within the production flow. In one embodiment of the present invention, the average unit volume of citrus byproduct will have at least 30 seconds or more of exposure to the blooming agent prior to the addition of the remaining liquid feed additives.

In one embodiment of the present invention, the raw commercial citrus byproduct is used as received from the citrus producer. In another embodiment of the present invention, the byproduct may be ground to achieve a smaller and more uniform particle size prior to use in the dry natural organic chemical carrier process. The smaller particle size may improve the performance of the citrus byproduct as a dry natural organic carrier, and results in a more uniform product in the production process. The byproduct may be ground using any commercial grinding apparatus as are known to those skilled in the art.

In one embodiment the byproduct may be ground to a maximum particle size of 0.04 inch. As appreciated by those skilled in the art, the particle size of a composition is typically expressed as a Mesh size designation. Mesh sizes in the animal feed industry are commonly expressed as US Sieve Designations or Tyler Designations. A mesh designates the number of openings and fractional parts of an opening, per lineal inch. Mesh is determined by counting the number of openings from the center of any wire to the center of a parallel wire, one inch in distance. In one embodiment of the present invention, the citrus byproduct may be ground to at least a 6 mesh Tyler screen designation, and more preferably, may be ground to pass through a 8 Tyler mesh screen size. In other alternative embodiments the carrier may be ground to pass through a 24 Tyler Mesh, with greater than 95% being captured, or not passing through, a 48 Tyler Mesh. The fines that can pass through the 48 Tyler Mesh are typically still used within the chemical carrier.

As may be appreciated by those skilled in the art, the dried citrus byproduct can easily be mixed with a many other generally used carriers such as vermiculite or bentonite. Such mixtures would be made in order to lower cost or adjust bulk density of the final mixture. For example, bentonite is less in cost than other carriers, but also less absorbent. Vermiculite is an absorbent carrier, but has a low bulk density and a higher cost than Bentonite. Fumed silica is a very absorbent carrier, but is expensive and has a very low bulk density. Dried beet pulp is very palatable, but is of limited supply. Any combination of the prior art chemical carriers noted may be used in conjunction with the citrus byproduct. The prior art carriers may be incorporated in the supplement composition prior to the blooming of the pre-mix, or may be added after the citrus byproduct is bloomed.

In a commercial feed mill, component products are mixed in highly automated processes . . . . Commercial feeds are generally made by a batch or a semi-continuous process that involves the mechanical mixing of desired ingredients. These mills generally also involves the moving of dry ingredients by automated and manual processes that may include screw and belt type conveyors, bucket elevators, pneumatic bins, bagging equipment, or manual movement and addition. It is extremely important that dry ingredients be dry and free flowing so that that they will be easily and completely integrated into finished feed. Also, ingredients must not tend to affect the final flow ability of the finished product, so that obstructions in conveying equipment are not formed.

The use of citrus byproduct as a chemical dry natural organic carrier produces a dry, free flowing and non-clumping composition, even at liquid inclusion rates of 55% by weight of the dry flake. The angle of repose is a generally accepted method of judging the flow-ability of solids. The angle of repose is determined as tan⁻¹ (height of pile)/(radius of pile). It is commonly determined by comparison to a know angle standard. Generally accepted standards for an angle of repose are given in Table III:

TABLE III

| | ANGLE OF REPOSE |
|---|---|
| FLOW RATING | (DEGREES) |
| Excellent | 25-30 or less |
| Good | 31-35 |
| Fair | 36-40 |
| Passable | 41-45 |
| Poor | 46-55 |
| Very Poor | 56-65 |
| Extremely Poor | 66-90 |

It is generally accepted that an angle of repose of less than 40° is free flowing. The higher the angle of repose, the more likely that the material will not move easily through feed mill equipment and bins. It is generally accepted that an angle of repose of more than 45° is unacceptable. In our tests we visually compared the angle of repose to a 45° angle. This is a widely used practice. Liquid was added until further addition resulted in an angle that was greater than 45° when compared to a known triangle. The chemical carrier when loaded with 50% by weight of liquid feed supplements exhibited an angle of repose of less than 40 degrees.

As may be appreciated to those skilled in the art, a “dry” feed supplement composition is one where liquid droplets are not present within the mixing vessel of the composition. The limit of a dry material is the condition up to the point where free liquid was observed on the sides of the test blender and no longer being absorbed onto the chemical carrier. As may further be appreciated by those skilled in the art, “Non-clumping’ composition is defined as the condition up to the point when agglomerations of particles do not separate on gentle pressure but remain together. This is evaluated visually by gentle horizontal finger pressure half-way up the height of an agglomeration. If the agglomeration shears cleanly it is “non-clumping”. Another method of determining if the composition is non-clumping is the ability to withstand an applied pressure of between 10 psi and 12 psi without the product clinging into aggregates or agglomerations larger than any of the individual pieces. This may be evaluated by squeezing a handful of the composition in question into a fist. If when opened, the composition crumbles out of the hand, it is non-clumping. If the composition remains as a single mass in the hand, it may be said to be a clumping or caking mixture.

### Sample Formulations

Test formulas were produced using inclusion rates of 1-55% by weight of desired liquid supplement ingredients onto dried citrus particles of different consistency in order to determine the absorbent capacity and palpability to animals. The second purpose of these tests was to determine if the resulting mixtures were dry, free flowing and free of caking upon storage. The third purpose was to produce products that reduced the vapor pressure of volatile organic and inorganic acids.

Milk Fever, or post-parturient hypocalcemia, is a disease of cows characterized by reduced blood calcium levels. It is common in the first few days of lactation, when demand for calcium for milk production exceeds the cow's body ability to mobilize calcium reserves. Low blood calcium levels interfere with muscle function throughout the body, causing general weakness, loss of appetite, and possible heart failure. The condition is more common in older animals (who have reduced ability to mobilize calcium from bone),

Milk Fever poses a threat to dairy herds feeding high-potassium forages. Potassium raises a cow's blood pH, making it more alkaline. A higher pH decreases the metabolism of calcium resulting in low blood calcium levels. That may cause either subclinical or clinical milk fever.

Anionic salts such as chloride counteract potassium by decreasing blood pH, making it more acidic. When fed to a close-up dry cow, 3 weeks prior to freshing/calving, the anions stimulate metabolism to make calcium more available. This will improve blood calcium levels and help prevent milk fever.

Urine pH levels are monitored to measure anionic effects. A pH range of 6.2 to 6.5 is generally accepted target for Holsteins, and a slightly lower range for Jerseys. Diet levels of anionic salts are increased or decreased to maintain the desired pH range.

A commonly used source of anions is incorporated on a dry carrier and added to the cows ration. For example, hydrochloric acid may be absorbed onto a dry carrier. It is desirable for the dry carrier to increase the palatability of the supplement. Since a cow's dry matter uptake often drops by up to 20 percent during a few days before calving, feeding an unpalatable product makes the situation worse.

A cow from the time of calving and 3 weeks after calving, commonly referred to as a “close cow,” faces many stresses. Among which is Ketosis a common metabolic disorder occurring during the first month of lactation in high producing dairy cows. Ketosis is a state in metabolism occurring when the liver excessively converts fat into fatty acids and ketone bodies. Glucose is regarded as the preferred energy source for all cells in the body with ketosis being regarded as a crisis reaction of the body to a lack of carbohydrates in the diet.

In order to increase carbohydrates for close cows, propylene glycol is commonly administered as a drench. This is labor intensive and requires skilled personnel, and sometimes results in death of cows due to drowning. An alternative method of administering propylene glycol is in the form of the glycol on a dry carrier. Palatability and ease of handling as well as economy are important. For example, one commercially available product consists of propylene glycol on a dried beet pulp carrier.

To test the palatability of the composition, a group of fifty commercial steers were divided into two groups of twenty five and fed a diet of wet brewer's grains mixed with a mineral premix. These calves were fed and cared for in the same manner for a period of 35 days when the specific additive (“feed additive O”) was added to the test group's diet. The formula for feed additive O consisted of:

| Ingredients | Percent (by weight) |
|---|---|
| Ground citrus flake | 48% |
| A solution of Propionic Acid and its ammonium | 4% |
| salts | |
| Propylene Glycol | 24% |
| Glycerine | 24% |

Feed was given free choice through out the trial and the feeder stock was allowed to eat until bunks were cleared. For this test the typical feed consisted of:

| Ingredients | Percent |
|---|---|
| Wet Brewer's Grains | 88% |
| Soybean Hulls | 6% |
| Hay (50/50 Fescue/Bermuda Blend) | 5% |
| Hi-Mag, High Vitamin A, Bovatech custom mineral blend | 1% |
| from Cargill | |

CONTROL GROUP

| | |
|---|---|
| Day 30 weight | 11125 pounds |
| Day 1 wt initial group weight | −9810 pounds |
| | 1315 total pounds gained/ |
| | 25 head |
| | 52.6 pounds per calf average gain/ |
| | 31 days feeding |
| | 1.70 pounds ADG per calf |
| Weight at mid-trial to final weight | |
| Day 45 wt | 11950 pounds-group total |
| Day 30 wt | −11125 pounds-group total |
| | 825 pounds total gain/ |
| | 25 head |
| | 33 pounds per calf/ |
| | 16 days |
| | 2.06 pounds ADG per calf |
| From start to finish | 11950 pounds finish group |
| Total Average weight for control | −9810 pounds start group |
| group | |
| | 2140 pounds total gain/ |
| | 25 head |
| | 85.6 ADG/calf total/ |
| Total period | 45 days |
| | 1.82 pounds ADG per calf |

TEST GROUP

| | |
|---|---|
| Day 30 wt | 10650 lbs |
| Day 1 wt Initial group weight | −9635 lbs |
| | 1015 total pounds gained/ |
| | 25 head |
| | 40.6 ADG per calf/ |
| | 31 days feeding |
| | 1.31 pounds ADG per calf |
| Weight at mid-trial to final weight | |
| Day 45 wt | 12150 lbs |
| Day 30 wt | −10650 lbs |
| | 1500 pounds total gain/ |
| | 25 head |
| | 60 pounds/calf/ |
| | 16 days |
| | 3.75 pounds ADG per calf |
| From start to finish | 12150 lbs |
| Total Average for test group | +9635 on day 45 |
| Finish | |
| Total gain | 2515 pounds total gain/ |
| | 25 head |
| Day 30 to | 100.6 pounds per head gained/ |
| Day 45 | 45 days |
| | 2.14 pounds ADG per calf |

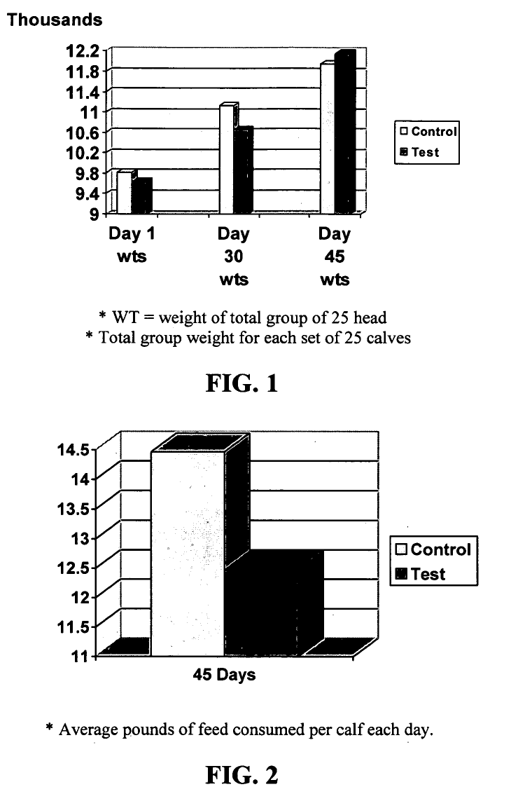

The test facility had scales which allowed for multiple calves to be weighed at the same time. In each of the weighing periods, multiple calves were weighed together and a cumulative weight was then recorded for each group. FIG. 1 represents the total weight for that group on that day.

### Feed Conversation was as Follows

| | |
|---|---|
| Test group was feed a total of | 31363 pounds of feed/ |
| Test group gained in 45 days | 2515 pounds of meat |
| | 12.47 pounds of feed to produce 1 |
| | pound of meat |

### Control Conversions are as Follows

| | |
|---|---|
| Control group was feed a total of | 31550 pounds of feed/ |
| Control group gained in 45 days | 2140 pounds of meat |
| | 14.74 pounds of feed to |
| produce 1 pound of meat | |
| Final wt for control group | 11950 |
| Final wt for test group | −12150 |
| | 200 pounds difference in |
| | group wt at trial end |
| Final feed consumed control group | 31550 pounds |
| Final feed consumed test group | −31368 pounds |
| | 187 pounds less feed consumed |
| | by test group over trial period |
| Calculated in total wt used | 1175 pounds feed additive O |
| * Total pounds fed to test group | +187 Difference |
| included | |
| 1175 pounds of feed additive O | 1362 pounds feed save |
| Feed Consumption | |

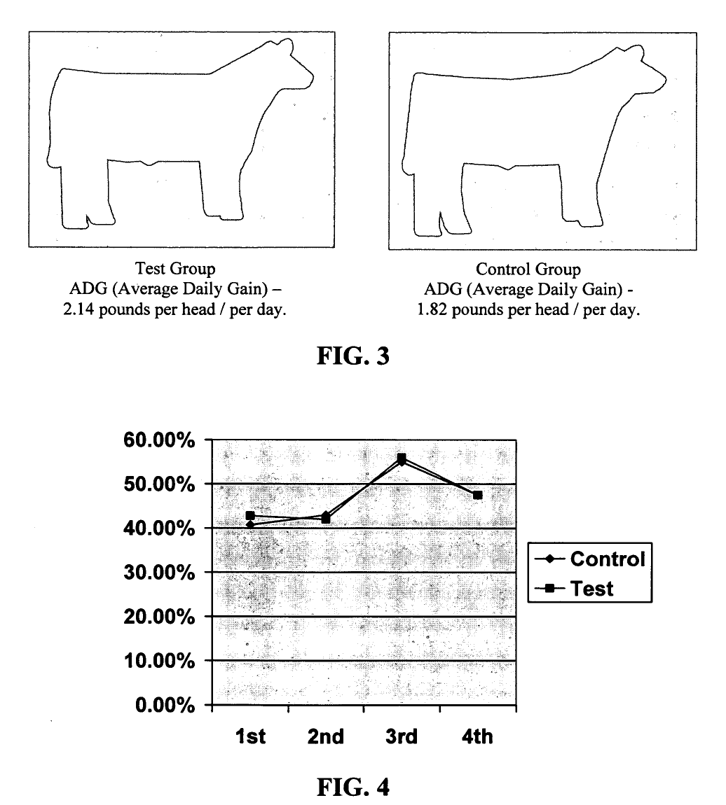

FIG. 2 shows the average pounds of feed consumed per calf each day. FIG. 3 shows the average daily weight gain per calf each day.

### Materials Used:

Two groups of 25 commercial steers each were fed either a test feed or a control feed. Steers were located at a beef feed lot. The control steers were fed a feed mixture containing wet brewer's grains and a mineral premix. The test group of calves was fed the same feed mix as the control group with the addition of feed additive O. Both groups of calves were fed free choice for the duration of the trial period and were given feed once a day.

### Other Materials Used

One AND Scale calibrated

L'eggs Every Day Knee High Suntan Sheer Toe Panty Hose (used to filter fecal samples)

### Process:

Fecal sample was mixed to form composite sample. One cup of composite fecal sample was taken and placed in the L'eggs panty hose. After doing so, the sample was weighed. After the weight was recorded the composite stool sample was washed until the water ran clear and then was hand wrung dry to remove excess water. After the composite sample was hand wrung dry, it was re-weighed.

The assumption was made that a decrease in the amount of particulate matter remaining in the fecal material would be indicative of rumen efficiency. These particulates that are passed through could have many factors affecting their digestibility (i.e. roughage type, amount of corn, etc.). But the basic hypothesis is that anything that allows the rumen to better utilize its primary feed source can be measured to some extent by measuring the amount of particulates remaining in the manure.

The test was set up to take a composite sample from each group, weigh it, filter it, and re-weigh it. The result should show that a more efficient rumen will have a smaller particle size and leave less mass on the screen to be weighed. Two groups of twenty five calves were put up and fed for 45 days on a diet of wet brewer's grains. After that one group was given an additive of one pound per head per day, mixed into its ration. The second group continued to be fed the same way only without the additive.

### Procedure to Test Digestibility of the Feed:

The procedure for obtaining fecal material was to collect a sample from multiple manure piles in each pen to form a composite sample (only one composite sample was obtained for each pen). The composite sample was then weighed, washed through a filter and reweighed.

1^{st} Collection

| | |
|---|---|
| Pen 1 - Composite sample used | 194 grams |
| Composite sample after wash | −74 grams = 40.75% left |
| Fine particulate that passed | 115 grams = 59.25% passed through |
| through difference | |
| Pen 2 (designated test pen) - | 194 grams |
| Composite sample used | |
| Composite sample after wash | −83 grams = 42.8% left |
| | 111 grams = 59.25% passed through |

Test Feeding Started 2^{nd} Collection
1^{st} samples taken after test feeding started

| | |
|---|---|
| Control group | |
| Initial sample Wt | 494 grams |
| Washed sample left | −210 grams = 43% left |
| Wt of what washed away | 284 grams = 57% passed |
| Test group | |
| Initial sample Wt | 488 grams |
| Washed sample left | −204 grams = 42% |
| Wt of what washed away | 284 grams = 58% |

3^{rd} samples taken

| | |
|---|---|
| Control group | |
| Initial sample Wt | 229 grams |
| Washed sample left | −126 grams = 55% |
| Wt of what washed away | 103 grams = 45% |
| Test group | |
| Initial sample Wt | 256 grams |
| Washed sample left | −144 grams = 56% |
| Wt of what washed away | 112 grams = 44% |

4^{th} and Last Samples taken

| | |
|---|---|
| Control group | |
| Initial sample Wt | 235 grams |
| Washed sample left | −159 grams = 47.5% |
| Wt of what washed away | 122 grams = 52.5% |
| Test group | |
| Initial sample Wt | 232 grams |
| Washed sample left | −110 grams = 47.5% |
| Wt of what washed away | 122 grams = 52.5% |

FIG. 4 illustrates the amount of sample left in the filter upon re-weight.

Although, there was a difference in the total weight gained and in the amount of feed taken to gain that weight, there appears to be little significant difference in the fecal material particle size.

In another embodiment of the present invention, a composition may be produced which is a general nutrition supplement for beef cattle. Such a product may use glycerin or propylene glycol for use as an energy source within the cow and metabolizes to glycogen in the liver of the animal. Organic acids in the feed, such as acetic, enhances the metabolism of the glycerin or propylene glycol in the liver of the animal into glycogen.

One sample formulation useful for cattle, poultry or swine the chemical carrier comprises:
50% Citrus Flake
43% Glycerin
7% Acidic Acid (active as ammonium acetate)
All % by weight

As stated above, cattle, poultry and swine may use a citrus flake, glycerin and propionic acid formulation as a source of fiber and energy. Another useful formulation for dairy cattle would be 50% propionic acid and 50% citrus flake. This formulation provides a dietary source of propionic acid to the dairy cow. Milking cows generally need extra propionic acid in their diet just before and after calving. Propionic acid is generally in short supply in the liver of transition cows, but is essential in the Krebs cycle for the digestion and use of foodstuffs in the dairy cow's diet. The bacteria in the dairy cows rumen needs propionic acid to produce milk, and acidic acids levels affect the butter fat of the mild produced. Other organic acids such as Butyric, Iso-Butyric and Valeric are generally in short supply in high milk production cows. Acids in the rumen are limiting factors on total milk production of the cow. A glycerin additive is used as an energy source within the cow and metabolizes to glycogen in the liver of the animal. Organic acids in the feed, such as acetic, enhances the metabolism of the glycerin in the liver of the animal into glycogen.

In another embodiment of the present invention, the raw citrus flake is pre-ground to obtain a uniform particle size, and to increase the surface area per unit volume of the flake available for acid absorption. The uniform particle size also aids the flow ability, the dry, non-clumping characteristics, of the resulting flake/acid mix. Propionic acid is then added to the citrus flake, and the organic acid/flake mixture is mechanically agitated or stirred for a period of 1 minute. The remaining desired liquids such as glycerin, and other desired acids such as hydrochloric or acidic may then be added to the treated flake and absorbed at the higher rate to reach up to an approximate 55% total absorption rate.

In another embodiment of the present invention, the chemical carrier mixture comprises:
25% Hydrochloric acid
15% propionic acid (present as ammonium propionate)
10% propylene glycol
50% citrus flake

The ammonium propionate is a solution containing the 91% propionic acid, 5% ammonia, and the balance water. The ammonium salt buffers the solution making it easier to handle, removes much of the smell and corrosive effects of the propionic acid. This also results in a unique way of buffering the hydrochloric acid in the feed mix. The ammonium salt does not form a strong bond with the propionate and readily transfers to the hydrochloric acid. This prevents the hydrochloric from being as volatile, the acid is less likely to evaporate, and is much easier to handle. The hydrochloric acid is used for the chlorate ion in the cattle rumen. The propionic acid and the propylene glycol are used in the Krebs cycle in milk production. The ammonium becomes, or is utilized, as feed protein nitrogen in the cow.

In the prior art, there are basic problems in the handling and transport of liquid acids for addition to cattle feedstuffs, and in premixed feedstuffs. Notably, there is a terrible odor with prior art acid additives. The use of citrus byproduct as a carrier results in a pleasing odor. The citrus flake acid mix does not burn the flesh, and may be handled without gloves. Prior art acid mixtures presented a corrosive handling problem. An acid may not simply be poured on existing feed, in that the acid will evaporate prior to the actual consumption by the dairy cow. By mixing the desired acids supplements with citrus flake, the acid is absorbed into the flake and will not evaporate in supplement transport. The mixture need only be kept in closed containers or bags during shipment to ensure the majority of the acid profile reaches the cows diet.

It is well accepted that salts, whether they be ammonium, sodium, potassium, calcium, or magnesium, of volatile organic and inorganic acids have a lower vapor pressure over solutions than the corresponding acid solutions on the same active acid basis. For example, the following Table II is for formic acid a volatile organic acid with a pungent odor.

TABLE II

| | | Vapor pressure of |
|---|---|---|
| Concentration of Acid | Concentration of Ammonia | acid over solution |
| 85% Formic Acid | 0% Ammonia | 24.2 hPa |
| 85% Formic Acid | 10% Ammonia | 4.3 hPa |

This same trend will hold true for other commonly used volatile acids, ie. hydrochloric, acetic and propionic. This fact is useful in formulating liquid additives onto dry absorbent carriers from the stand point of reducing the exposure to workers from pungent fumes and odors. By incorporating a salt of the organic or inorganic acid the vapor pressure of the acid over the solution is reduced. Also, the release of volatile components from the finished feed can be controlled to some extent by proper buffering of acidic volatile components. A salt is the product of the chemical reaction of an acid being neutralized by addition of a base. Ammonium Propionate is the product of propionic acid being neutralized by ammonia. In a combination of acids, where there is not enough base to completely neutralize both acids, the base will associate with the strongest acid. For example: formic acid is stronger than acetic acid. In a solution that is combination of formic, acetic and ammonia where there is not enough ammonia to neutralize all the acid the available ammonia will first associate principally with the formic to make the salt ammonium formate then the acetic to make the salt ammonium acetate. The un-neutralized acid will be largely acetic acid and the pH will be less than 7.0 which is neutral.

As an illustration of this effect test formulations using citrus byproduct in flake form, were loaded with liquid acid supplement formulations. The citrus flake was bloomed by the addition of an acid blooming agent prior to the addition of the remainder of the liquid supplements. The following test formulations were produced:

Test A:

| | | |
|---|---|---|
| Dried Citrus Peel | 25.0 lbm | |
| 30% Hydrochloric Acid | 12.5 lbm | Mix 1 minute |
| Addition 2 consisting of | 7.5 lbm | Mix 2 minutes |
| 65% Propionic acid | | |
| ammoniated to pH 4.5 | | |
| Proplyene glycol | 5 lbm | |

| | |
|---|---|
| Comment | Very little ammonium chloride |
| | vapor noticed. |

Test B:

| | | |
|---|---|---|
| Dried Citrus Peel | 25.0 lbm | |
| 65% Propionic acid | 7.5 lbm | Mix 1 minute |
| ammoniated to pH 4.5 | | |
| Addition 2 consisting of | 12.5 lbm | Mix 2 minutes |
| 30% Hydrochloric Acid | | |
| Proplyene glycol | 5 lbm | |

| | |
|---|---|
| Comment | More ammonium chloride vapor |
| | noticed than in test A, but |
| | dissipated quickly. |

Test C:

| | | |
|---|---|---|
| Dried Citrus Peel | 25.0 lbm | |
| 30% Hydrochloric Acid | 12.5 lbm | Mix 1 minute |
| Addition 2 consisting of | 12.5 lbm | Mix 2 minutes |
| Propionic acid | | |
| Proplyene glycol | 5 lbm | |

| | |
|---|---|
| Comment | No ammonia used as buffer. |

Test formula A represents a product where the bulk of the liquid feed additive is ammoniated to form a salt of the acid. Test formula B represents a product where the blooming agent is ammoniated to form a salt of the acid. Test formula C represents a straight acid formulation with no salts used to buffer the vapor pressure of the component acids. To test the volatility five (5) 500 gram samples from each of Test A, Test B, and Test C were spread onto a 16 inch plastic disk and left uncovered at ambient conditions 25 C night and 35 C during the day for 36 hours.

At the conclusion of the 36 hours period, each test formulation was weighed and the total averaged. The average weight loss for each test formulation indicates volatile components lost to evaporation. The volatile components include hydrochloric acid, propionic acid, ammonia, water.

| | Weight lost | % Weight lost |
|---|---|---|
| Test A | 8 gms | 1.6% |
| Test B | 9 gms | 1.8% |
| Test C | 22 gms | 4.4% |

As can be seen by the test data below, the inclusion of a salt of the acid used for blooming, or a salt of the acid of the desired liquid nutritional supplement, results in a much lower volatility of the final mixture composition. The practical effect of this is less odor for the supplement production personnel, less evaporation of the liquid supplements during transport, and more useful nutritional supplements being provided to the animal.

All of the compositions and process disclosed and claimed herein can be made and executed without undue experimentation in light of the present disclosure. While the compositions and processes of this invention have been described in terms of preferred embodiments, it will be apparent to those of skill in the art that variations may be applied to the compositions and process and in the steps, or in the sequence of steps, of the methods described herein without departing from the concept, spirit, and scope of the invention. More specifically, it will be apparent that certain chemical compounds which are both chemically related, and similar physical characteristics, may be substituted for the chemical compounds described herein while the same or similar results would be achieved. All such similar substitutes and modifications apparent to those skilled in the art are deemed to be within the spirit, scope, and concept of the invention.

We claim:

1. A process for the creation of an animal nutritional feed supplement composition; the process comprising;
the use of an absorbent chemical carrier, the chemical carrier comprising citrus byproduct obtained from citrus juice expressing, said citrus byproduct comprising citrus peel and being in a dried state;
adding a blooming agent to the chemical carrier to form a pre-mix;
mixing the blooming agent by means of mechanical agitation uniformly into the citrus byproduct for a period of time, wherein the blooming agent blooms the citrus byproduct within the pre-mix;
adding liquid feed supplements to the bloomed chemical carrier; and
the liquid feed supplements then being substantially absorbed by the chemical carrier to form a substantially dry feed supplement composition.

2. The process of claim 1, wherein the time period is greater than 30 seconds.

3. The process of claim 1, wherein the dried citrus byproduct has a moisture content between about 5% and 12% by weight.

4. The process of claim 1, wherein the blooming agent is at least one of the group comprising formic, acetic, propionic, butanoic, lactic, citric, caprylic, capric, caproic, valeric, butaric, acid, trimethyl glycine, choline, lysine, or certain other amino acids, or a combination of a preceding acid with its salt in solution.

5. The process of claim 1, wherein the blooming agent comprises Propionic Acid.

6. The process of claim 5, wherein the blooming agent comprises a water solution of propionic acid and ammonium proprionate.

7. The process of claim 1, wherein the blooming agent is added to the chemical carrier in a ratio of between 1% to 5% on an active acid basis of the weight of the dried citrus byproduct.

8. The process of claim 1, wherein the liquid feed supplements comprise at least one of an organic or medium chain fatty acid selected from the group comprising formic, acetic, propionic, butanoic, lactic, citric, caprylic, capric, caproic, valeric, butaric acid, or a combination of a preceding acid with its salt in solution, trimethyl glycine, choline, lysine, glycerin, or certain other amino acids.

9. The process of claim 1, wherein the liquid feed supplements comprise at least one of an inorganic acid selected from the group comprising phosphoric, sulfuric or hydrochloric acid.

10. The process of claim 1, wherein the liquid feed supplements comprise at least one of glycerin or propylene glycol.

11. The process of claim 1, wherein liquid feed supplements are added to the bloomed dried citrus carrier in a ratio of between 10% to 55% of the weight of the dried citrus byproduct.

12. The process of claim 1, wherein the feed supplement composition is a free flowing mixture having an angle of repose of less than 40 degrees.

13. The process of claim 1, wherein the feed supplement composition is non-clumping.

14. The process of claim 1, wherein prior to use in the chemical carrier composition, the citrus flake is ground by mechanical means to produce a particle size finer than a 6 mesh Tyler screen designation.

15. The process of claim 1, wherein the liquid feed supplements absorbed onto the bloomed citrus byproduct carrier which when fed in the diet of a cow with subclinical hypocalcemia, positively affect the negative dietary cation-anion difference which governs calcium metabolism.

16. The process of claim 1, wherein the liquid feed supplements absorbed onto bloomed citrus byproduct carrier which when fed to a cow post calving, would provide a source of energy, organic acids and fiber.

17. An animal nutritional feed supplement composition; the composition comprising;
an absorbent chemical carrier composition, the chemical carrier comprising citrus byproduct obtained from citrus juice expressing, said citrus byproduct including citrus peel and being in a dried state, the chemical carrier having between about 10 and about 100 volume percent of the citrus byproduct, and up to 90 volume percent of a secondary chemical carrier other than citrus byproduct;
a blooming agent added to the chemical carrier to form a pre-mix, wherein the blooming agent is mixed into the chemical carrier for a period of time; and
liquid feed supplements which are added to the pre-mix, the liquid feed supplements then being substantially absorbed by the chemical carrier to form a substantially dry feed supplement composition.

18. The composition of claim 17, wherein the secondary chemical carriers comprise beet pulp, brewers grains, distillers grains, soybean meal, peanut hulls, expanded vermiculite, Bentonite, fumed silica, or cotton seed meal.

19. The composition of claim 17, wherein the blooming agent is at least one of the group comprising formic, acetic, propionic, butanoic, lactic, citric, caprylic, capric, caproic, valeric, butaric acid, trimethyl glycine, choline, lysine, or certain other amino acids, or a combination of a preceding acid with its salt in solution.

20. The composition of claim 17, wherein the blooming agent comprises Propionic Acid.

21. The composition of claim 20, wherein the blooming agent comprises a water solution of propionic acid and ammonium proprionate.

22. The composition of claim 17, wherein the blooming agent is added to the chemical carrier in a ratio of between 1% to 5% on an active acid basis of the weight of the dried citrus byproduct.

23. The composition of claim 17, wherein the liquid feed supplements comprise at least one of an organic or medium chain fatty acid selected from the group comprising formic, acetic, propionic, butanoic, lactic, citric, caprylic, capric, caproic, valeric, butaric acid, or a combination of a preceding acid with its salt in solution, trimethyl glycine, choline, lysine, glycerin, or certain other amino acids.

24. The composition of claim 17, wherein the liquid feed supplements comprise at least one of an inorganic acid selected from the group comprising phosphoric, sulfuric or hydrochloric acid.

25. The composition of claim 17, wherein the liquid feed supplements comprise at least one of glycerin or propylene glycol.

26. The composition of claim 17, wherein liquid feed supplements are added to the bloomed dried citrus carrier in a ratio of between 10% to 55% of the weight of the dried citrus byproduct.

27. The composition of claim 17, wherein the feed supplement composition is a free flowing mixture having an angle of repose of less than 40 degrees.

28. The composition of claim 17, wherein the feed supplement composition is non-clumping.

29. The composition of claim 17, wherein prior to use in the chemical carrier composition, the citrus flake is ground by mechanical means to produce a particle size finer than a 6 mesh Tyler screen designation.

30. The composition of claim 17, wherein the liquid feed supplements absorbed onto the bloomed citrus byproduct carrier which when fed in the diet of a cow with subclinical hypocalcemia, positively affect the negative dietary cation-anion difference which governs calcium metabolism.

31. The composition of claim 17, wherein the liquid feed supplements absorbed onto bloomed citrus byproduct carrier which when fed to a cow post calving, would provide a source of energy, organic acids and fiber.

32. A process for the creation of an animal nutritional feed supplement composition; the process comprising;
the use of an absorbent chemical carrier, the chemical carrier comprising citrus byproduct obtained from citrus juice expressing, said citrus byproduct comprising citrus peel and being in a dried state;
adding a blooming agent to the chemical carrier to form a pre-mix;
mixing the blooming agent by means of mechanical agitation uniformly into the citrus byproduct for the time period greater than 30 seconds, wherein the blooming agent blooms the citrus byproduct within the pre-mix;
adding liquid feed supplements to the bloomed chemical carrier in excess of 30% of the weight of the dried citrus flake; and
the liquid feed supplements then being substantially absorbed by the chemical carrier to form a substantially dry, free-flowing, feed supplement composition.
